(19) United States
(12) Patent Application Publication
(10) Pub. No.: US 2011/0054960 A1
(43) Pub. Date: Mar. 3, 2011

(54) DYNAMIC WEB PAGE CREATION

(75) Inventors: Tarun Bhatia, Simi Valley, CA (US); Darshan V. Kantak, Pasadena, CA (US); Eric T. Bax, Altadena, CA (US); Ramazan Demir, Sherman Oaks, CA (US)

(73) Assignee: Yahoo! Inc., a Delaware corporation, Sunnyvale, CA (US)

(21) Appl. No.: 12/547,088

(22) Filed: Aug. 25, 2009

(51) Int. Cl. G06Q 30/00; G06F 17/00; G06Q 10/00

(52) U.S. Cl. 705/7; 715/243; 705/14.73

(57) ABSTRACT

Briefly, in accordance with at least one embodiment, a method or apparatus capable of creating or generating web pages dynamically (or a portion thereof) is disclosed.

### BACKGROUND

Publishers of online content, such as via the Internet, typically generate revenue through advertising. An online publisher of content receiving a web page request from a user typically serves web pages that include both advertising type content and non-advertising type content. An online publisher in this approach may get paid for a user “click” through or a user action in response to advertising type content or advertisement. Determinations as to content and layout of a web page may therefore have potential to affect revenue for an online publisher. A need thus exists for continuing improvements in techniques and processes to make such determinations.

### BRIEF DESCRIPTION OF THE FIGURES

Non-limiting and non-exhaustive embodiments will be described with reference to the following figures, wherein like reference numerals refer to like parts throughout the various figures unless otherwise specified.

FIG. 1 is a schematic diagram illustrating one implementation or embodiment for satisfying or meeting a typical user request for a web page or a portion thereof;

FIG. 2 is a schematic diagram illustrating one implementation or embodiment of a system to perform dynamic web page creation or a portion thereof; and

FIG. 3 is a schematic diagram illustrating an embodiment of a network which may include a system to perform dynamic: web creation or a portion thereof.

### DETAILED DESCRIPTION

In the following detailed description of embodiments, reference is made to accompanying drawings which form a part hereof, and in which it is shown by way of illustration specific embodiments of claimed subject matter. It is to be understood that other embodiments may be used, for example, or changes or alterations, such as structural changes, may be made. All embodiments, changes or alterations, including those described herein, are not departures from scope with respect to intended claimed subject matter.

Some portions of the detailed description included herein may be presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

A goal of content providers may be to effectively balance monetization potential with presentation of content and a corresponding user experience. This has historically been the case for traditional print media, and is currently the case for online publishers. Unfortunately, complexity and a large number of competing variables may make it difficult to either measure or systematically achieve such a balance.

At one extreme, a Web page may be designed with many ads with hope that a user viewing a page will be likely to select one in response to a reasonable or large volume of ads made available. However, this may also not be an effective approach if it produces a relatively negative user experience which may have a correlative effect on monetization performance for an online publisher. On the other hand, placing too few ads on a page may result in missed monetization opportunities.

A lack of available tools or metrics for understanding balancing monetization with user experience may be further exacerbated by the nature of conventional Web page design. That is, conventional Web page designs typically are relatively static in terms of space allocated for advertising versus non-advertising type content. Such an approach to page design may not take into account that an appropriate balance may be different for different users, content, etc.

In the context of web page layout, an appropriate or better balance between monetization and user experience may theoretically be achievable. Here, embodiments of claimed subject matter are provided to permit evaluating or predicting monetization performance of web pages to enable dynamic generation of web page layouts with reference to a particular individual or a given set of circumstances, e.g., specific user, type of content, time of day, etc. It is believed that such an approach will result in improved monetization over existing approaches. Of course, claimed subject matter is not limited in scope to a particular implementation provided. Many variations are possible, including those described herein, all of which are within the scope of claimed subject matter.

Examples of specific embodiments will now be described. It should be noted that, while the following examples are described with reference to web page layouts, embodiments may be employed for generating or evaluating layouts for any type of content representation or display of information delivered via any of a wide variety of communication channels, including, for example, via electronic or optical communication systems.

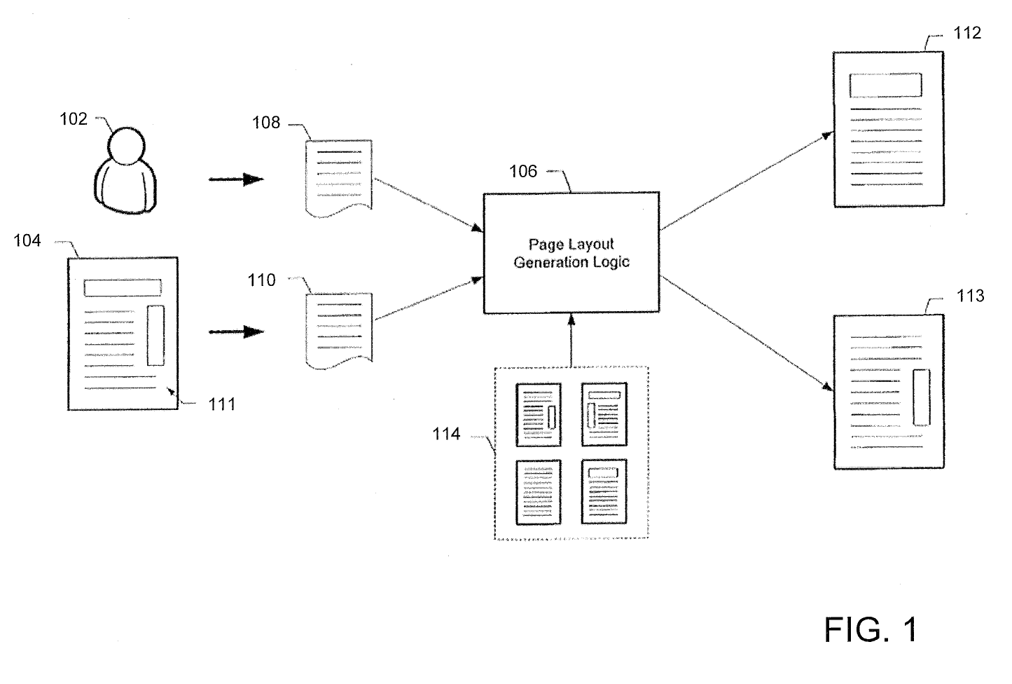

Referring to FIG. 1, in response to a request from user 102 for a web page 104, electronic information for generating a page layout may be provided to page layout generation logic 106. In this example, electronic information may include at least two general categories of electronic information. A first set or type 108 (generally referred to herein as electronic user information) may include any of a wide variety of electronic information relating to a user to whom a page is to be presented (or relating to a group or population segment to which a user belongs) including, for example, who a user is (e.g., user profile including expressed preferences), where a user is from (e.g., birthplace or current location), or any other demographic characteristics or attributes. In some embodiments, this may also include electronic user engagement information representing a user's online behavior. This may include, for example, any information representing a user's browsing history, search history, interactions with content, advertisements, search results, etc. (potentially across multiple distribution channels). Time of day may also be included, as well as season or time of year, and any of a variety of other temporal variables such as, for example, average time spent on previous page(s), previous search(es), etc.

A second set or type of electronic information 110 (generally referred to herein as electronic content information) includes attributes or characteristics relating to or associated with a page (or portion thereof) being laid out for presentation to a user, e.g., source of a page (e.g., what web site), a size of a source (e.g., how large or small a site), a type of page (e.g., commercial, non-commercial, contextual, informational, etc.), type of content on a page (e.g., format or type including but not limited to text, images, video, animation, etc.), a country from which page content originates or to which page content is being served, etc. Another aspect may be by what communications channel content is being delivered including, but not limited to, desktop computer, television, gaming device, cable television apparatus, mobile telephone or other mobile device, automobile information system, physical installation, etc. According to some embodiments, content module weighting might be included as well. That is, it may be the case that a publisher of a page intends or desires to emphasize some content modules over others. Therefore, embodiments are contemplated in which weights may be assigned to different modules to maintain a particular emphasis in generated web page layouts.

Based at least in part on available electronic information, for example, page content 111 (e.g., ads, non-advertising content, etc.), and possibly other electronic information as well (e.g., type of channel through which the page is to be delivered, time of day, a proportion of the content corresponding to a particular content type, category of page content (e.g., community/social networking, news, political, etc.), etc.), a page (e.g., 112 or 113) may be instantiated using a selected or generated layout and presented to a user. In a particular embodiment, as shall be described in greater detail below, such a page layout as well as content selection for presentation may be dynamically generated. Therefore, for an embodiment, template layouts of content targeted at specific audiences is not necessarily being specifically or solely applied. Again, a particular or served page (or portion thereof) may be generated dynamically in response to a user request. According to a particular embodiment, a layout may be dynamically generated by a system based at least in part, for example, on electronic information, as mentioned above, as well as other dynamic real-time electronic information, various appropriate context-specific weighting factors, or various appropriate context-specific constants, for example, that may be employed in real time. Thus, if a specific type of user requests a specific type of page (possibly via a specific delivery channel, for example), a system may generate a page customized to promote a specific user experience as represented by a particular page layout, as explained in more detail below. It is, of course, noted, that such an approach may also be applied to a subset, sub-portion or selected portion of a web page, rather than to an entire web page.

In this particular context, it may be desirable to introduce some generally accepted terminology relevant to the particular technology. For example, ‘CPM’ is an abbreviation for Cost Per Thousand (M is roman numeral for 1,000) impressions. In this context, the term impression refers to a download by a user of a web page or a portion thereof. This refers to a pricing model where a sponsor, such as an advertiser, pays an online publisher for impressions generated by ad placement. ‘CPC’ is an abbreviation for Cost Per Click. This refers to a pricing model where a sponsor, such as an advertiser, pays the publisher if a user clicks on a particular placement. In this context, the term placement refers to content, such as ad or non-ad type content, for example, which may be placed in a selected location on a web page. In this context, the term eligible placement refers to a placement that is eligible to be placed in a particular available location on a web page. A publisher makes no money unless a user clicks. In this context, the term click refers to a user action indicating selection of a hyperlink or the like via which a user may select content, another web page, or the like, to be viewed typically via a user's client browser. Publishers assume risk here and, therefore, attempt to predict likelihood of a click from a user in connection with determining ads to show or present on a web page. ‘CPA’ is an abbreviation for Cost Per Action. This refers to a pricing model where a sponsor, such as an advertiser, pays a publisher if a user completes an action, such as registering on a landing page to which a user is diverted after clicking on an ad, or buying a product, for example. ‘eCPM’ is an abbreviation for estimated Cost per Thousand Impressions. This refers to a measure that allows paid ads from different pricing types to be compared on a normalized basis of impressions. It refers to an expected payment per 1,000 impressions. If a publisher estimates that a $0.50 CPC ad will likely get 4 clicks per 1,000 impressions, then it has a $2 eCPM value. Similarly, a $4 CPA that is likely to get 1 conversion per 4,000 impressions has a $1 eCPM value. In this context, a conversion refers to an event in which a user clicks on content, views a landing page, and eventually performs a transaction, such as an item purchase. It is a desirable goal for advertisers to get conversions from online ads, and to get them at a low average cost. This approach allows ads from different pricing models to be ranked by evaluating them in terms of eCPM. The term bid here refers to a sponsor's willingness to pay, such as for impressions, clicks, or actions, for example. Here, the term PPC is an abbreviation for Pay per Click. It also may be used interchangeably with CPC or PPC_Bid. Here, p(click) refers to probability of a click on a hyperlink or other icon by a user. Likewise, the term p(action|click) refers to probability of an action given a click occurs. Finally, relationship [1] below is considered in this particular context be to definitional with reference to the prior terms:

eCPM=p(click)*(PPC_Bid) [1]

Currently, ad type and non-ad type content are treated as separate, distinct categories with little overlap if rendered on a web page to a user, for example. Regions of a page are typically earmarked to hold either non-ad content or ads during layout design, and applied thereafter to virtually all page view instances in one simple approach. Although more complex approaches may employ more than one layout template, more complex approaches would be nonetheless similar. Specific eligible placements that may occupy these regions are selected by competition from within an earmarked category. For example, selection of eligible ads occurs for a space allocated to an ad unit, and selection of non-ad content may occur from within a non-ad content category. However, layout design constraints in general may curtail effective page space utilization in the sense that a more effective utilization of a page space may be made if constraints were relaxed. Additionally, a distinction that is viewed to exist in online content delivery between ad-type content and non-ad content may blur over time as ads provide more information over time unrelated to a purchase opportunity and vice-versa.

Therefore, in this context, an embodiment of claimed subject matter may provide a method or approach in which a more dynamic, more efficient, or more unified allocation of page space may be accomplished among eligible placements from non-ad type content or ad type content categories.

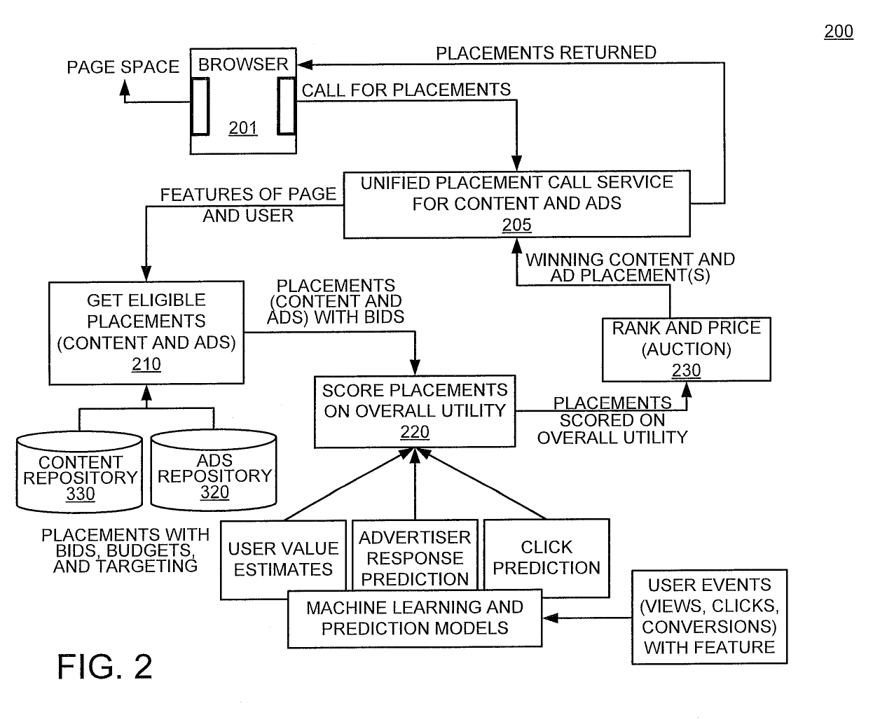

Although claimed subject matter is not limited in scope in this respect, referring to FIG. 2, an embodiment 200 of a method of allocating space on a web page to eligible placements may be described with reference to the figure. At a high level, which shall be described in more detail below, eligible placements for a web page are identified. This is accomplished or executed, for example, for this particular embodiment, by block 210 in FIG. 2. Likewise, once eligible placements are identified, those eligible placements may be scored. Scoring may be performed, for example, for a particular embodiment, at block 220. Eligible placements may be selected and allocated to particular locations or spaces on a web page, based at least in part on scoring that result. For an embodiment, this may be accomplished using a ranking of scored placements, as illustrated by block 230. For a particular embodiment, although claimed subject matter is not necessarily limited in scope in this respect, pricing may also be determined.

For an embodiment, both allocating content and layout of eligible placements may take place over at least a portion of a web page. Therefore, it is not necessary to do so for an entire web page in all embodiments. As previously discussed, eligible placements include at least advertisement-type content and non-advertisement-type content. It is noted, however, that eligible placements may also include links to third-party web sites. As non-limiting examples, links to third-party web sites may include links to application websites or links to articles posted by others other than a particular online publisher. In this particular context, the term advertisement or advertisement type content refers to a communication containing information that is intended to assist in encouraging purchase of a product or service by those receiving a communication.

For a particular embodiment, as described in more detail below, scoring includes computing estimates of publisher, advertiser and user utility. This aspect of a particular embodiment may comprise a departure from other approaches to web page layout and content selection. Typically, publisher utility or at least publisher revenue comprises a consideration in other approaches. Likewise, some approaches may attempt to account for advertiser revenue in some fashion. However, one particular approach may take into account ‘utility’ for multiple participants in an overall process, such as publisher, advertiser and user. In this context, utility refers to a measure of relative satisfaction that may be experienced by various individuals or entities, from having an eligible placement appear in a particular location on a web page or portion thereof. Although a particular embodiment takes utility of publisher, advertiser and user utility into account, it is noted that various embodiments may be employed to weight these differently to reflect relative value within a particular publisher revenue generation process. Thus, some publishers, for example, may chose to weight user considerations more or less in terms of long term generation of revenue.

A feature of a particular embodiment with scoring may include estimating advertiser response prediction. In one embodiment, for example, as explained in more detail below, advertiser response prediction may include estimation using a machine learning prediction process. Likewise, scoring may also include estimating user value. This estimation also may involve using a machine learning prediction process. Furthermore, scoring may include estimating click prediction as well. These aspects are provided in much more detail below.

A particular embodiment of allocating space may also include a bidding mechanism among entities competing for space on a web page, e.g., page space. Therefore, in one sense, a market may be simulated to make more effective decisions regarding allocation of space on a page or portion thereof. One advantage in such an embodiment, therefore, is that layout and content of a web page may be resolved concurrently. Likewise, another advantage of such an embodiment is that layout and content of a web page may be resolved dynamically for any particular web page rendering to an end user, as described immediately below.

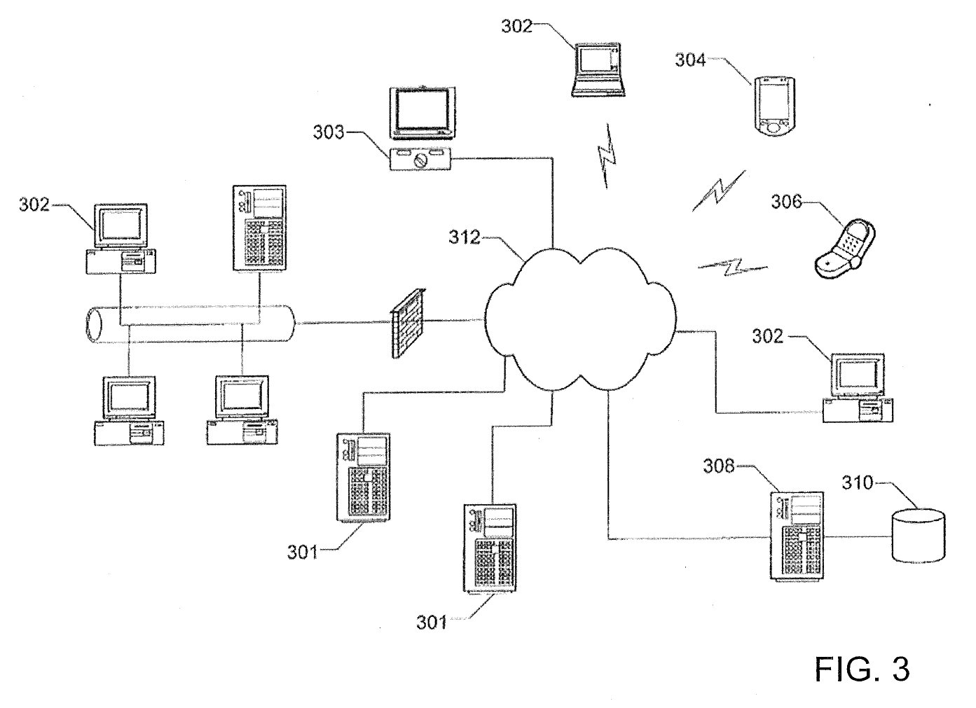

As illustrated in FIG. 3, for a particular embodiment, content providers may submit application links or article placements, and enter bids (CPM, CPC, or CPA), budgets, or targeting criteria into a content repository 330 which may contain bided and non-bided non-ad type content. Likewise, advertisers may submit ad-type content, enter bids, budgets, targeting criteria, as they typically do, into an ad repository 320 that may contain both bided and non-bided ads.

Referring again to FIG. 2, a user may request a URL from a browser, depicted as 201. Browser 201 may direct a request to an online publisher's web server. The server may then make a single call for placements for a page space to a matching and placement selection service, depicted in FIG. 2 as 205. A placement selection service for a particular embodiment may receive a call for page space, along with page and user attributes (features). Service 205 may then perform an internal look-up and add to this list any additional attributes (features), for example, using internal mapped information or other insights from available information. Of course, claimed subject matter is not limited in scope to this particular feature. Using a more complete list of attributes (features), service 205 may make a single call to get ad and content placements from repositories 330 and 320, those repositories being described previously. A component in such an embodiment may get this call and search for eligible placements across content and ad repositories 330 and 320. This component was previously described above as 210 in FIG. 2. It may then forward these placements and their bid values to a scoring component 220, also previously described. Eligibility component 210 may match placement features with user and page features, and may also attempt to satisfy other business conditions, such as verifying a placement provider has not filtered out such opportunities, a publisher or user has not filter them out, and may additionally verify that opportunities identified do not exhaust budgets if non positive bids are applied, as well as other criteria. Eligible placements may then be returned along with bid values in such an embodiment.

Continuing, illustrated by FIG. 2, for example, returned placements may be scored on an overall utility function, which in a particular embodiment may include user utility, publisher utility, and advertiser utility. Formulation of such a utility function for a particular embodiment shall be described in more detail later. However, it shall be appreciated that claimed subject matter is not limited in scope to a particular utility function formulation. A virtually limitless variety of such utility functions may be formulated and remain within the scope of claimed subject matter.

As alluded to previously, formulation of a utility function may include estimation of user value, which may comprise a positive or negative adjustment to be applied to a bid. Such an approach may be employed in a particular embodiment to enable non-bided content placements to be assigned a positive value, or annoying ads with low performance and high bids to be adjusted down before entering an auction phase, depicted by 230 in FIG. 2. Content interactions may also be tracked and placement utilities scored in a similar fashion in an embodiment, although claimed subject matter is, again, not limited in scope in this respect.

As detailed below, response prediction estimates may be obtained for eligible placements specific to a user for determining eCPM values for publisher utility. Similarly, advertiser response prediction estimates may be obtained for computing advertiser utility. Weights may be applied to compute overall utility function for a placement. It is noted here that multiple eligible placements may be obtained for all locations or spaces on a web page in this approach, assuming an entire web page is being rendered, for example.

In a next auction phase, depicted in FIG. 2 by 230, placements may be ranked using utility scores to determine a winning or top placement(s) and their positions within a space they will occupy. Likewise, for a particular embodiment, prices (costs) may be computed using a generalized second price model, described in more detail below, where a placement for any position may occur by paying enough to displace a next highest scored placement. Placements may then be assigned to positions within a page space and returned to browser 201. Furthermore, as a user interacts with placements for a particular web page, events may be generated that are tracked and analyzed to continue to improve performance estimates

A machine learning and prediction module may be employed to apply bucket testing and an empirical framework for observing user interactions with placements. Such an may involve attributes associated with a particular page, user, and placement to learn or identify those features that are more likely to generate a favorable user response. In one particular embodiment, these estimates may be continually learnt and refined to improve predictive performance for placements, and may be employed in a utility function for arbitrating across placements. Machine learning may provide one approach to automating aspects of a process to handle scaling issues for dynamically creating web pages, for example.

The following are non-limiting examples of placement types from ad type and non-ad type content categories that may compete concurrently for space on a page in some embodiments. These examples are provided merely for purposes of illustration and are not meant to limit the scope of claimed subject matter in any way.
Advertisements (ad-type content category)—This category may include messages to build brand perception or invite specific action from a user to register for a service or purchase a product. A message could be from a content provider, advertising their service to users, such as for a news provider, a social interaction site, or a magazine. Advertisements may be paid, or carry no payments or bids, such as ads for an online publisher or public service announcements. Clicking on an ad may typically lead to a sponsors landing page.
Application Links (non-ad type content category)—This category may include icons for an application offered by a provider where a user is able to interact with an application. A user may already be registered. Customizations may include application-specific or user-specific alerts, such as new messages, new friend activity, or a recently beaten high score, as a few non-limiting examples. These may also include links to social networking sites, games, messaging, email, not for profit organizations, such as NPR or BBC, etc. Application links may be paid, or carry no payments or bids, such as application links for a particular online publisher, or links to applications offered by entities having a relationship with an online publisher. These may also be added by a user action.
Article Links (non-ad type content category)—This category may include graphical or textual links to a story that invites a user to a publisher's domain. A user may receive links to a favorable story or article that may promote traffic to a publisher's site, to thereby potentially generate additional traffic for a site, for example.

As explained previously, an aspect of a particular embodiment may relate to generating a utility function that may include three components—publisher, advertiser, and user utility. Again, a variety of approaches to formulating such a utility function are possible. The following example is provided only as an illustration; therefore, the scope of claimed subject matter is not intended to be limited to this particular example. The possibilities for such utility functions are virtually limitless.

A single unifying function may be employed to score placements across content categories in a chosen decision framework. However, this is merely one particular embodiment and other embodiments are possible within the scope of claimed subject matter without being so limited. In a particular embodiment, however, total utility for constituents may be estimated—here, for a user, advertiser, content provider, and publisher. This could be of the following form, although, of course, again claimed subject matter is not limited in scope to a particular approach or embodiment: x1*publisher utility+x2*adv utility+x3*user utility, where x1, x2, x3 are coefficients that scale respective utilities. For example, scaling coefficients may be employed so that utilities are comparable or instead, as previously suggested, to emphasize a particular subset of one or more utilities over one or more others.

In a particular embodiment, Publisher Utility is employed to measure expected revenue to a particular online publisher from paid placements, which, in one particular embodiment, may comprise a function of at least the following, for example:
bids associated with placements, expressed in terms of eCPM values to account for various pricing types (e.g., CPC, CPA)
performance estimates or probability of revenue generating user response for placements. This may include clicks on placements or conversions on a link that follows.
   Publisher utility for a particular embodiment may be measured in terms of yield, which may comprise immediate, mid-term, and long-term impact on revenue likely to be earned from chosen placements for a particular user. Such an may be summarized in the table below:

TABLE ONE

| PUBLISHER UTILITY | If show ad-type content: | If show non-ad type content: |
|---|---|---|
| If User Views Content | (1) Get paid e-CPM $ | (2) May have to pay or get |
| | | paid for paid content |
| | | placements |
| If User Clicks on Content | $0 (lose user and session | (3) User continues session, |
| | ends) | potentially earning session |
| | | revenue |
| Long Term Effect of Showing | (4) Good quality brand ads | (5) More engaging sessions |
| | increase positive | and longer ones; may invite |
| | perception of publisher. | friends for content sharing. |

In the above, term (1) may be viewed as cost to an advertiser, which, for a particular embodiment, may be determined using a theory of a generalized second price auction. Under such an approach, a sponsor may pay a little more to displace a next highest bidder. This may be expressed in terms of the following relationships:

eCPM_{—}{i}>=eCPM_{—}{i+1}, [2]

where i is the rank of the advertiser from being scored. However, for PPC campaigns, instead, for an embodiment, the following relationships may be employed:

PPC_{—}{i}*p(click)_{—}{i}>=Bid_{—}{i+1}*p(click)_{—}{i+1} [3]

PPC_{—}{i}Bid_{—}{i+1}*p(click)_{—}{i+1}/p(click)_{—}{i}+small amount [4]

For an embodiment, those relationships may be applied to paying actions, where bid refers to cost per action (e.g., impression, click, or conversion) and p(action) is probability for an action (for this embodiment, 1 is employed in a case of a CPM campaign; otherwise, it may be estimated using prediction response techniques, described in more detail below, for other payment schemes other than CPM). Resources regarding generalized second price auction, and auction theory for determining ranking and pricing of various competitive placements include the following: Milgrom, P. (2004). Putting Auction Theory to Work. Cambridge University Press, New York; Krishna, V. (2002). Auction Theory. Academic Press, New York. Of course, claimed subject matter is not limited to employing particular approaches such as may be provided by these works or sources.

Term (2) may be viewed for an embodiment as related to a business relationship of a particular online publisher with one or more content providers. In some cases, this value could be negative, such as if a publisher pays a content provider for a placement, or positive such as if a content provider pays to have its content appear on a page to attract users to its domain, for example. For other content situations, such as an application placement link, for example, a table of outcomes would be similar to ad-type content in that a user may end a session, for a particular embodiment.

Term (3) may be viewed as related to a part of session revenue that may be foregone if a user leaves after clicking to an advertiser's placement. It is possible to estimate average session lengths and revenue streams associated with different types of users, for example.

Terms (4) and (5) may be challenging to estimate. However, term (4) for a particular embodiment, for example, may be viewed as estimating user perception using a proportion of high quality brand ads to low quality brand ads, for example. Likewise, another approach might measure variation in user base and metrics regarding being engaged during a session. Term (5) may be estimates for an embodiment by tracking users that share content. This thereby invites more ad views from other users, and value to an online publisher may therefore be higher than users that do not.

Generalized second price auction, and auction theory is suggested above for determining ranking and pricing of various competitive placements; in contrast, estimating user response prediction may involve using Statistics Regression techniques, such as Linear and Non-Linear Regression; as well as non Parametric Techniques such as Support Vector Machines, Neural Networks, and Kernel Methods to estimate probability of a response by a user. Resources regarding these topics include, for example: Neural Networks for Pattern Recognition by Christopher M. Bishop; Kernel Methods for Pattern Analysis by John Shawe-Taylor, Nello Cristianini; and Statistical Learning Theory by Vladimir N. Vapnik. Again, claimed subject matter is not limited to employing particular approaches such as may be provided by these works or sources.

Advertiser Utility in a particular embodiment may be employed to measure how likely an opportunity is to initiate desired user response for an advertiser or content provider's objective. For an embodiment, utility may be high if, for example, a user is likely to perceive a placement as useful and have a positive association, by interacting and following through with subsequent actions like purchase or seeking an advertiser's products elsewhere. This, of course, may typically extend beyond estimating or measuring clicks on a placement. For an embodiment, this might be estimated via machine learning processes or techniques from features active in an opportunity and a learnt ability for those features to invoke a desired response.

Estimating utility for an advertiser may involve contemplating a number of alternative possibilities. While an advertiser may pay per impression or click, different users may deliver different value and, hence, return on investment to an advertiser. Some users that see an ad may never notice or be influenced by it, while others may seek out more information. Some users may click, but never convert (register or buy) while others may immediately convert. Even those that convert may represent different value to an advertiser (a non qualifying buyer, for instance).

Although claimed subject matter is not limited in scope to employing this particular approach, one particular approach or technique for estimating advertiser utility along these lines is discussed in U.S. patent application Ser. No. 12/415,846, filed on Mar. 30, 2009, titled “System and Method for An Online Advertising Exchange with Submarkets Formed by Portfolio Optimization,” by Eric Bax, Krishna Prasad Chitrapura, Sachin Garg, Darshan Kantak, Anand Kuratti, and Joaquin Delgado, and assigned to the assignee of currently claimed subject matter.

User Utility for a particular embodiment may be considered to measure impact to user experience, for which relevance may comprise one metric. For example, in one approach, a distance function in feature space may be evaluated for features associated with a placement and those associated with a user and a page or portion thereof. A poor experience from irrelevant, annoying, or too many placements, for example, would be expected to reduce a user's utility from a page and reduce a likelihood of future visits from a particular user. This could be represented as an additional value in a utility function, which may be positive or negative and which may be employed to adjust a bid entering an auction. A bid, for example, may be zero for a non-paying placement, as an example, but a positive adjustment as a result of user utility may make it a feasible candidate for use on a web page.

User value may be estimated a variety of ways and claimed subject matter is not limited in scope in this respect. For example, estimations may be based at least in part on observed user events, including views of placements or types of placements, if a user ignores or selects a placement or an amount of time a user spends engaging with applications or landing pages that follow. These events along with features for an event may allow estimation of a likely value a user finds in potential placements that are in an eligible set.

For example, in one embodiment, although claimed subject matter is not limited in scope in this respect, a ranking function for placements may employ the following form:

P(click)*(PPC_Bid+α) [5]

where α is an estimate of placement's impact on user utility, learnt or estimated from user interaction data. The value of a may be positive or negative. A positive value, for example, may indicate a user's repeatedly clicking on a link or spending a lot of time on an application, such as a finance application link, as an example. A negative value, for example, may indicate if users click on a link but do not engage much, or an application that does not load quickly enough, for example. Such data may be collected across users for a placement and used in predicting a values for individual placements and features. For a particular embodiment, therefore, if PPC_Bid=0, but α>0, an adjusted bid times probability of click may allow relevant or high quality non-paid content placements to appear on a rendered web page.

Various features of a selection and individual placements in relation to a user's specific preferences and features may assist in determining user utility. For example, numbers of ad-type versus non-ad-type content, relevance to requested resource, preference or frequency of usage for a user for content placements, quality attributes of ads or content links (e.g., latency, security, annoyance, inappropriateness, etc), and more. Users engagement or consumption patterns may be related to such measures in estimating user value, using, for example, unsupervised learning methods, such as may be known to one of ordinary skill in the relevant art. Again, resources regarding this latter topic may include, for example: Neural Networks for Pattern Recognition by Christopher M. Bishop; Kernel Methods for Pattern Analysis by John Shawe-Taylor, Nello Cristianini; and Statistical Learning Theory by Vladimir N. Vapnik. Again, claimed subject matter is not limited to employing particular approaches such as may be provided by these works or sources.

An embodiment of a system may predict utility of a user's action (e.g., view, click, conversion) for an advertiser based at least in part on features of a user or features of ad-type content or non-ad type content, for example. Although claimed subject matter is not limited in scope in this respect, aspects of this are also discussed as part of the previously cited patent application, “System and Method for An Online Advertising Exchange with Submarkets Formed by Portfolio Optimization.” One approach to estimation may be referred to as response prediction, mentioned previously. In this context, this is intended to refer to a prediction of a user clicking on content that has been shown on a web page or portion thereof. It is often useful to know a probability with which a click may happen. As suggested, one approach to estimating probability may involve applying machine learning or other statistical techniques to historical user data, such as user click data. In some cases, the amount of such information, for example, may be enormous.

In some situations, however, instances may occur for which there is no history or little prior history. In such cases, estimates may be assigned using regression or collaborative filtering techniques. These situations, for example, typically may be assigned to similar items or item profiles, whose properties may be borrowed, until there is sufficient information from learning to more accurately predict a response. Although claimed subject matter is not limited in scope in this respect, learning phase techniques such as those described in various sources or works mentioned in various places in this document may be employed, although claimed subject matter is not limited to employing particular approaches such as may be provided by these sources or works. Likewise, explore-exploit trade off techniques or collaborative filtering techniques may also be employed. Examples of explore-exploit trade off techniques are described, for example, in the following, although claimed subject matter is not limited in scope to employing the approaches provided by these particular works or sources:
Gittins, J. C. “Bandit Processes and Dynamic Allocation Indices.” Journal of the Royal Statistical Society. Series B (Methodological), Vol. 41, No. 2. (1979), pp. 148-177.
Gittins, J. C. and D. M. Jones, “A Dynamic Allocation Index for the Discounted Multiarmed Bandit Problem.” Biometrika Vol 66, No. 3. (1979), pp. 561-565.
Gittins, J. 1989. Multi-Armed Bandit Allocation Indices. John Wiley and Sons, New York
   Likewise, examples of collaborative filtering techniques are described in the following, although, again, claimed subject matter is not limited in scope to employing the approaches provided by these particular works or sources:
Resnick, Paul and Hal R. Varian. “Recommender Systems.” Communications of the ACM. Vol 40, No. 3 (1997), pp. 56-58.
Schafer, J. Ben, Dan Frankowski, Jon Herlocker, and Shilad Sen. “Collaborative Filtering Recommender Systems.” Lecture Notes in Computer Science, Springer Berlin/Heidelberg (2007), pp. 291-324.
Cosley, D., S. Lawrence, and D. M. Pennock. “REFEREE: An open framework for practical testing of recommender systems using research index.” In 28^{th} International Conference on Very Large Databases, VLDB 2002. Hong Kong, Aug. 20-23, 2002.
Pazzani, M. and D. Billsus. “Learning and revising user profiles: The identification of interesting web sites.” Machine Learning, 27:313-331, 1997.
Resnick, P., N. Iacovou, M. Suchak, P. Bergstorm, and J. Reidl. “GroupLens: An Open Architecture for Collaborative Filtering of Netnews.” In Proceedings of ACM 1994 Conference on Computer Supported Cooperative Work. pp 175-186. Chapel Hill, N.C., 1994.
Billsus, D. and M. Pazzani. 1998. Learning Collaborative Information Filters. ICML 1998:46-54.
Sarwar, B., G. Karypis, J. Konstan, and J. Reidl. Item-Based Collaborative Filtering Recommendation Algorithms. In Proceedings of WWW10. May 2001.
Breese, J. S., D. Heckeman, and C. Kadie. “Empirical Analysis of Predictive Algorithms for Collaborative Filtering.” In Proceedings of the Fourteenth Annual Conference on Uncertainty in Artificial Intelligence, 43-52, July 1998.
Hofmann, T. Latent semantic models for collaborative filtering. ACM Trans. Inf. Syst. 22(1):89-115, 2004.

Online publishers may additionally, if desired, control how much to value short-term monetization versus long-term impact on user experience. Together these applied controls and user, advertiser, and publisher utility may be employed in one or more embodiments, for example, as described herein, to enable dynamic resolution of placements across content types. Estimates of performance may be derived using machine-learning techniques that evaluate various attributes or features of users, pages (or portions thereof), placements, or other aspects, against particular combinations that may generate a more favorable user response, for example. Experimentation with placements during a learning phase may be employed to generate information to be evaluated and which may be employed, if desired, to evaluate at least in part features that may contribute to a desired interaction from a user with attributes for a placement. For example, features or attributes that may be relevant to a process may include but not restricted to:
User
   IP address
   Geographic location
   Demographic information
   Behavioral information (e.g., search or display session information)
   Recent history of engaging with content
   User device employed
   Browser version employed
   Interaction profile in terms of average sessions length, intensity of interaction with respect to content, etc.
   Customizations, preferences, favorites, etc.
   Time at user's location
Page
   Type of page
   Contextual classification of content on page
   Size of page space
   Restrictions on page space
Placement
   Targeting applied
   Placement format
   Placement location
   Placement size
   Placement constraints

An embodiment of in accordance with claimed subject matter may be employed to invoke competition from more than one of the above types of placements for a requested page by a user. Space on a page has a potential to hold any one of a variety of placements which may be quite diverse in terms of content or type. Placements that are eligible to compete and appear on page may or may not have bids submitted by a provider. In one embodiment, content providers may provide placements for all three previously described categories, for example—advertisements to solicit new users to try a provider's content or application or invite existing users to utilize content or services; application links for new users to try or existing users to be notified about and engage with providers'services; or article links for specific articles or stories that are featured on providers' sites.

In this context, page space corresponds to specific units of space on a page (or portion thereof) for particular locations. If there is insufficient utility from placements for a particular space, in some embodiments, it may be given up altogether to a content area on a web page, for example. Interaction among different page spaces on a page may also in some embodiments be managed by resolving them together, and expressing the overall set of placements in terms of a single utility function, for example.

In accordance with claimed subject matter, therefore, dynamic assignment of space to content may be employed in an embodiment. A layout design constraint would therefore typically be relaxed. As a result, page space may be opened up for placements of various types content to occupy, as previously discussed, and this assignment may be dynamically resolved per page view request, in an embodiment, for example. Likewise, competition among content via auction may be employed in an embodiment. For example, a single unified auction may be employed to allocate space across eligible placements vying for particular spaces. A single evaluation may improve efficiency by soliciting eligible placements from within content categories concurrently versus a sequential approach where, for example, a highest ranking placement within one category may later compete with a highest ranking placement in another category for a particular space at issue. Likewise, in an embodiment, content providers may additionally submit bids to pay for better placement within a particular page space. Advertisers currently bid for placement of ads, of course. Likewise, content provider bids are not required, of course. Therefore, various aspects in accordance with claimed subject matter may vary depending on the particular embodiment.

In one embodiment, for example, a single utility function may be employed to rank and/or price placements. A function encompassing publisher, advertiser, and end user utility, such as previously described, for example, may be employed to arbitrate among competing content placements. Likewise, depending again on the particular embodiment, estimates of user value may be employed in a function, which may be positive or negative, allowing for non-paying content placements with high user utility to displace irrelevant or annoying paid content, for example.

Of course, layouts may likewise evolve over time to take into account additional information representing how various population segments, for example, may interact with resulting pages. Such an evolution might involve, for example, introduction of more electronic information, refinement of user behavior or preferences, or newly defined population segments, etc. Evolution of dynamic layouts may be facilitated in a wide variety of ways including, for example, using supervised or unsupervised machine learning techniques including, for example, use of performance frequency counting, weighting models, or prediction processes. For example, some small percentage of pages presented in response to user requests may be devoted to experimental purposes. Such pages might include manual or automatically generated variations from one or more page layout(s) which may ordinarily be dynamically created. User engagement data or page monetization performance data may then be used in conjunction with any of a variety of machine learning techniques to identify page layout characteristics which may correspond to desirable improvements, and then those characteristics may be incorporated into system operation. Of course, claimed subject matter is not limited in scope to these particular aspects.

According to a particular implementation, a selection of a particular page layout may entail a choice between one or more layouts for particular population segments. As indicated previously, for example, this might be useful where there is little or no information available about a particular user requesting a page, or where a user does not map to any relevant population segments. In such cases, a default layout might be employed. Similarly, a choice between a targeted layout and a default layout might be predicated on a particular delivery channel.

A wide range of variables may be considered in various embodiments of the invention. For example, as previously suggested, information relating to a user requesting a page may include any demographic information such as, for example, age, gender, geographic location, user engagement data (e.g., page views, browsing history, search history, advertising history, etc.), explicitly or implicitly expressed interests, etc. In addition, as previously suggested, information relating to a page being requested may include, for example, a site from which a page originated (e.g., Yahoo!, eBay, etc.), a country of origin, a type of content on a page (e.g., news, shopping, etc.), content-module weighting, etc. Moreover, embodiments are not limited to entirely dynamic generation of layouts for content. For example, an embodiment may be dynamic a portion of time or on a periodic basis for a given demographic or target audience rather than each time a page is requested, for example.

Embodiments may also be employed in a variety of contexts. For example, an individual web site operator may employ techniques described herein to serve different layouts of its web page content to different segments of a population of users that visit, thereby enhancing user experience or improving various monetization opportunities embodied therein. According to an embodiment, as alluded to previously,techniques may be employed on larger scales to enable layout generation across many domains. Embodiments may be employed to develop or generate layouts for content (e.g., web page layouts) in any of a wide variety of computing contexts. For example, as illustrated in FIG. 3, implementations are contemplated in which a population of users may interact with content publishers (e.g., web sites 301) via a diverse network environment using any type of computer (e.g., desktop, laptop, tablet, etc.) 302, media computing platforms 303 (e.g., cable and satellite set top boxes and digital video recorders), handheld computing devices (e.g., PDAs) 304, cell phones 306, or any other type of computing or communication platform.

As will be understood, layouts created for presentation on any particular device or display type or channel may be modified for presentation on any other device or display type. Layouts generated may be processed or provided in some centralized manner. This is represented in FIG. 3 by server 308 and data storage 310 which, as will be understood, may correspond to multiple devices and data storage devices. Alternatively, layouts likewise in an embodiment may be generated in a much more distributed manner, e.g., at individual web sites, or for specific groups of web sites. Claimed subject matter may also be practiced in a wide variety of network environments including, for example, TCP/IP-based networks, telecommunications networks, wireless networks, etc. These networks are represented in FIG. 3 by network 312, for example. Layouts generated may then be provided to users via various channels through which users may interact with a network. In addition, a computer program or software instructions with which embodiments may be implemented may be stored in any type of computer-readable media, and may be executed according to a variety of computing models including a client/server model, a peer-to-peer model, a stand-alone computing device, or according to a distributed computing model in which various functionalities, as described herein may be effected or employed at different locations. Although claimed subject matter is not limited in scope in this respect, of course, one embodiment may include an article comprising: a storage medium having stored thereon instructions such that a computing platform is able, as a result of said instructions being executed by said computing platform, to dynamically create or generate a web page (or a portion thereof). Although again it should be noted that this is merely an illustrative example and that claimed subject matter is not limited in this regard.

It will, of course, also be understood that, although particular embodiments have just been described, claimed subject matter is not limited in scope to a particular embodiment or implementation. For example, one embodiment may be in hardware, such as implemented on a device or combination of devices, as previously described, for example. Likewise, although claimed subject matter is not limited in scope in this respect, one embodiment may comprise one or more articles, such as a storage medium or storage media, as described above, for example, that may have stored thereon instructions that if executed by a specific or special purpose system or apparatus, for example, may result in an embodiment of a method in accordance with claimed subject matter being executed, such as one of the embodiments previously described, for example. As one potential example, a specific or special purpose computing platform may include one or more processing units or processors, one or more input/output devices, such as a display, a keyboard or a mouse, or one or more memories, such as static random access memory, dynamic random access memory, flash memory, or a hard drive, although, again, claimed subject matter is not limited in scope to this example.

In the preceding description, various aspects of claimed subject matter have been described. For purposes of explanation, specific numbers, systems, or configurations may have been set forth to provide a thorough understanding of claimed subject matter. However, it should be apparent to one skilled in the art having benefit of this disclosure that claimed subject matter may be practiced without those specific details. In other instances, features that would be understood by one of ordinary skill were omitted or simplified so as not to obscure claimed subject matter. While certain features have been illustrated or described herein, many modifications, substitutions, changes or equivalents may now occur to those skilled in the art. It is, therefore, to be understood that the appended claims are intended to cover all such modifications or changes as fall within the true spirit of claimed subject matter.

1. A method of allocating space to eligible placements on a web page served by at least one server, comprising:
identifying said eligible placements for said web page served by at least one server;
scoring said eligible placements; and
allocating space to selected eligible placements based at least in part on the scoring of said eligible placements;
wherein said eligible placements include at least the following: advertisement content and non-advertisement content.

2. The method of claim 1, wherein said allocating space includes allocating content and layout of eligible placements over at least a portion of said webpage.

3. The method of claim 2, wherein said eligible placements also include links to third-party web sites.

4. The method of claim 3, wherein said links to third-party web sites include links to application websites.

5. The method of claim 3, wherein said links to third-party websites include links to articles.

6. The method of claim 1, wherein said allocating space includes: ranking said eligible placements to determine said selected eligible placements.

7. The method of claim 6, wherein said ranking includes pricing said selected eligible placements.

8. The method of claim 1, wherein said scoring includes computing estimates of publisher, advertiser and user utility.

9. The method of claim 8, wherein said publisher, advertiser and user utility are weighted to reflect relative value within a publisher revenue generation model.

10. The method of claim 1, wherein said at least one server comprises multiple servers.

11. An article comprising: a storage medium having stored thereon instructions executable by a specific purpose computing platform to: identify eligible placements for a web page served by at least one server; score said eligible placements; and allocate space to selected eligible placements based at least in part on the scoring of said eligible placements; wherein said eligible placements include at least the following: advertisement content and non-advertisement content.

12. The article of claim 11, wherein said instructions are further executable by said computing platform to allocate content and layout of eligible placements over at least a portion of said web page.

13. The article of claim 11, wherein said instructions are further executable by said computing platform so that said eligible placements include links to third-party web sites.

14. The article of claim 13, wherein said instructions are further executable by said computing platform so that said eligible placements including said links to third-party web sites further include links to application websites.

15. The article of claim 13, wherein said instructions are further executable by said computing platform so that said eligible placements including said links to third-party web sites further include links to articles.

16. An apparatus comprising: a specific purpose computing platform;
said specific purpose computing platform having a capability to identify eligible placements for a web page served by at least one server; score said eligible placements; and to allocate space to selected eligible placements based at least in part on the scoring of said eligible placements; wherein said eligible placements include at least the following: advertisement content and non-advertisement content.

17. The apparatus of claim 16, wherein said specific purpose computing platform further having a capability to allocate content and layout of eligible placements over at least a portion of said web page.

18. The apparatus of claim 16, wherein said specific purpose computing platform further having a capability to select eligible placements that include links to third-party web sites.

19. The apparatus of claim 18, wherein said specific purpose computing platform further having a capability so that selected eligible placements including said links to third-party web sites further include links to application websites.

20. The apparatus of claim 18, wherein said specific purpose computing platform further having a capability so that selected eligible placements including said links to third-party web sites further include links to articles.
